(19) United States
(12) Patent Application Publication
(10) Pub. No.: US 2010/0295323 A1
(43) Pub. Date: Nov. 25, 2010

(54) Machine For Generating Electricity

(76) Inventor: Mehmet Tatlisarap, Ankara (TR)

Correspondence Address: VENABLE, CAMPILLO, LOGAN & MEANEY, P.C., 1938 E. OSBORN RD, PHOENIX, AZ, 85016-7234, US

(21) Appl. No.: 12/514,450

(22) PCT Filed: Sep. 6, 2007
(86) PCT No.: PCT/TR2007/000087

§ 371 Date: Jun. 7, 2010

(30) Foreign Application Priority Data
Sep. 6, 2006 (DE) 10 2006 042 411.5

(51) Int. Cl. H02K 7/18; F03G 7/10

(52) U.S. Cl. 290/1 C; 74/DIG. 9

(57) ABSTRACT

Present invention relates to simple energy generator operating in simple leverage mechanism. The claimed inventive machine converts the increasingly acquired energy in to any other form received from first arm and increasingly forwarded to the following arm by way of a leverage mechanism. According to the invention the machine comprise many vigor arms and ancillary arms. Each vigor arms transmits the power to the following arm as increased by the ancillary arms. This process finally circles the final crankshaft and transmits the energy to a dynamo which shall convert the mechanical energy to the electrical energy. As per the claimed invention generating energy shall be cheaper, environment friendly and silent.

In physics leverage power and creating much more power than the energy supplied is a known principle. Leverage principle is commonly used in many of the prior machines. Since a leverage arm is a power carrying mechanism, the effect and the result is created by turning the leverage arm on its own axis.

Since the leverage is used to move something by using less power, the claimed invention is built on this leverage principle

Load arm×load force=effort arm×effort force

The claimed process and product shall be an alternative and substitute all the energy generator which are hazardous for the environment, which are so complex, unrecyclable, and expensive

The first initiative power is provided to the claimed machine from an electric motor or any kind of mechanical energy supplied to the machine. The crankshaft (KW1) is firstly operated by this electric motor. The cycling power supplied by this electric motor is constant to the clockwise direction as shown in FIG. 1 by arrow 1. The cycling power supplied to the crankshaft (KW1) is transmitted to the final crankshaft by lever arms (K1, K2, K3, K4, K5) and ancillary arms (H1, H2, H3, H4, H5, H6) and more powerful crankshaft cycling is generated at the final crankshaft (KW2)

For instance, if 4 of the mentioned leverage machine is mounted on the main shaft (W) each arm which receives cycling power of 90° shall transmit the power to the final crankshaft (KW2) and a power of 360° shall be acquired. The number of the combined leverage system or machine shall not apply any additional load to the electric motor and furthermore shall let the first and second crankshaft operate more accurately and conveniently.

### EXPLANATIONS OF FIGURES

FIG. 1: View of the system from above

KW1—first crankshaft

KW2—second crankshaft

K1—first leverage arm

K2—second leverage arm

K3—third leverage arm

K4—fourth leverage arm

K5—fifth leverage arm

H1—first ancillary arm

H2—second ancillary arm

H3—third ancillary arm

H4—fourth ancillary arm

H5—fifth ancillary arm

H6—sixth ancillary arm

S1, S3, S4, S5, S8, S11, S12 S3—connection rods

S2, S5, S7, S9, S10—resistance rods

### DETAILED DESCRIPTION OF THE INVENTION

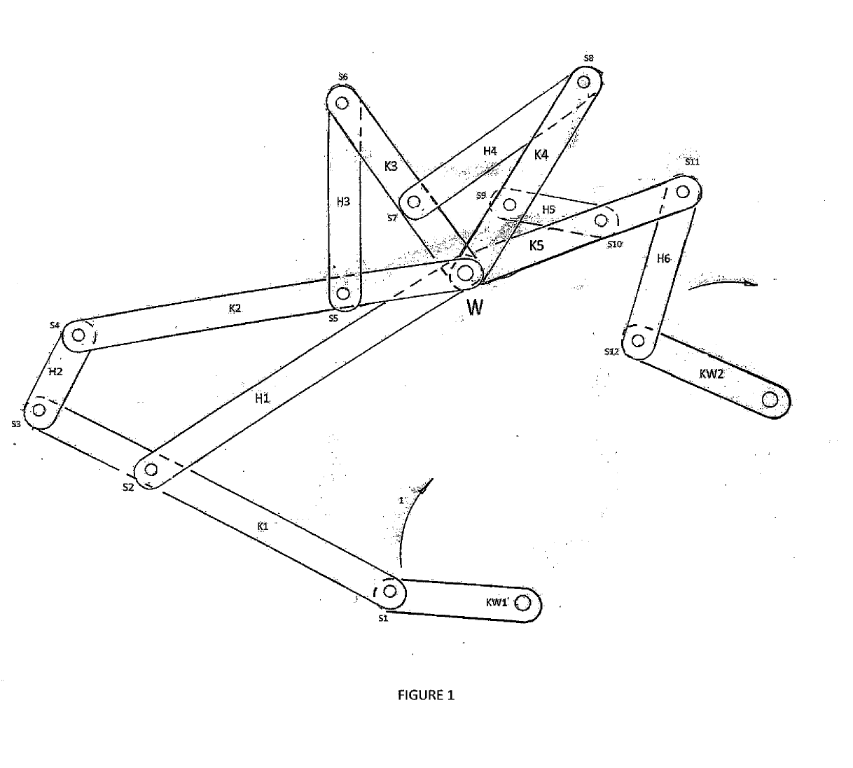

The parts of the system are explained in more detail hereby; the first leverage arm (K1) is forced to move right side by the power transmitted from first crankshaft (KW1). As per the leverage principle first leverage arm (K1) creates much more power on the short part of the arm (K1) affecting by the resistance point (S2) on the first ancillary arm (H1). The power on the first leverage arm (K1) is then transmitted to the second leverage arm (K2) trough second ancillary arm (H2) and the second leverage arm (K2) use this power as an initiative power. The leverage principle is again in use thereon. The second leverage arm (K2) transmits the accumulated power to the third leverage arm (K3) trough third ancillary arm (H3), third leverage arm (K3) transmits the accumulated power to the fourth leverage arm (K4) trough fourth ancillary arm (H4), fourth leverage arm (K4) transmits the accumulated power to the fifth leverage arm (K5) trough fifth ancillary arm (H5), fifth leverage arm (K5) transmits the accumulated power to the second crankshaft (KW2) trough sixth ancillary arm (H6). A dynamo is connected on the latter end of the second crankshaft (KW2) which transfers the mechanical energy to the electric energy. The leverage arms (K2, K3, K4, K5) are even connected on their latter parts to a main shaft (W). As many as needed system shown in FIG. 1 may be mounted on the main shaft (W).

None of the parts mentioned in the system is fixed to any of other. The points shown as S2, S5, S7, S9, S10, refers to the resistance points of the leverage system. As per the leverage principle these points are located to be closer to the power transmitting part of the arm. The connections of the resistance rods (S2, S5, S7, S9, S10) are made by pivoting pins providing connected part to move freely on their axis. Those pivoting pins let the movement transmitted to the latter part. The points referred as S1, S3, S4, S5, S8, S11, S12 in FIG. 1 are indicating the connection rods of the ancillary arms to the leverage arms. These points are even same structure with the resistance points.

Since the first crankshaft (KW1) operates by a low power the energy consumed shall be law. However the second crankshaft (KW2) empowered by the accumulated power generated by the leverage system shall cycle the dynamo much more powerfully. This process generates much more electric energy than the supplied electric energy.

A part of the electric energy generated by this process may also be diverted to the electric motor supplying electrical energy to the first crankshaft (KW1). The remaining part may be used for any need of electricity.

1. (canceled)

2. (canceled)

3. A machine for generating electricity by using the leverage principle having first crank shaft, an initiative electric motor giving the initiative motion on the first crankshaft, characterized in that; the first leverage arm connected to the first crankshaft by a connection rod, first ancillary arm connected to the first leverage arm by a resistance rod, second ancillary arm connected to the first leverage arm by a connection rod, second leverage arm connected to the second ancillary arm by a connection rod, third ancillary arm by a connection rod, four ancillary arm connected to the third leverage arm by resistance rod, fourth leverage arm connected to the fourth ancillary arm by a connection rod, fifth ancillary arm connected to the fourth leverage arm by resistance rod, fifth leverage arm connected to the fifth ancillary arm by a resistance rod, sixth ancillary arm connected to the fifth leverage arm by a connection rod, second crankshaft connected to the sixth ancillary arm by a connection rod and a main shaft on which the latter part of the first ancillary arm, the latter part of the second leverage arm, the latter part of the third leverage arm, the latter part of the fourth leverage arm, the latter part of the fifth leverage arm are connected and a dynamo which transfers the mechanical energy to the electrical energy.

4. A machine for generating electricity as mentioned in claim 1, characterized in that the resistance rods are located to be closer to the power transmitting part of the arm.

5. A machine for generating electricity as mentioned in claim 1, characterized in that the part of the electricity generated by the dynamo connected to the second crankshaft may be diverted to the electric motor connected to the first crankshaft.
